(19) United States
(12) Patent Application Publication
(10) Pub. No.: US 2020/0043078 A1
(43) Pub. Date: Feb. 6, 2020

(54) USER DEVICE TRIGGERED, IN-STORE, ORDER PICKUP

(71) Applicant: Apple Inc., Cupertino, CA (US)

(72) Inventors: Sonal Patidar, San Jose, CA (US); Filip Krsmanovic, Palo Alto, CA (US); Yingfeng Su, San Jose, CA (US); Douglas Park, Palo Alto, CA (US); Mangalore Nitin Bhandary, San Jose, CA (US); Pallavi Gholkar Homan, Palo Alto, CA (US)

(21) Appl. No.: 16/128,384

(22) Filed: Sep. 11, 2018

Related U.S. Application Data
(60) Provisional application No. 62/712,605, filed on Jul. 31, 2018.

(51) Int. Cl. G06Q 30/06

(52) U.S. Cl. CPC G06Q 30/0635

(57) ABSTRACT

Systems, methods, and devices are disclosed for automatically notifying a user through a notification on their mobile computing device that they have an order available for express in-store pickup after the user enters a particular store. The notification can initiate a communication directly to the back-of-house system for the particular store to cause a back-of-house store associate to present the order to the user—all without the user having to attract the attention of an often busy front-of-house store associate.

### CROSS REFERENCE TO RELATED APPLICATIONS

This application claims priority from U.S. Provisional Application No. 62/712,605, entitled “USER DEVICE TRIGGERED, IN-STORE, ORDER PICKUP,” Filed on 31 Jul. 2018, which is incorporated by reference in its entirety, for all purposes, herein.

### TECHNICAL FIELD

The present technology pertains to in-store, order pickups, and more specifically pertains to a user device to communicate with systems within the store to initiate an order pickup.

### BACKGROUND

Over the last decade retail stores have been shifting to models that emphasize experiences with products for sale. This shift has resulted in the collateral effect that store associates are often engaged with customers experiencing the products, and it can be difficult for a customer that might need quick help to find a store associate available to assist—or at least the customer might have to wait for a store associate to become available. In some instances this can cause an unpleasant experience for a customer and solutions to this problem are needed.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example store floor plan showing general locations of computing devices within and outside of the store in accordance with some aspects of the present technology;

FIG. 2 illustrates an example method embodiment performed by a mobile computing device in accordance with some aspects of the present technology;

FIG. 3 illustrates an example method embodiment performed by a server(s) associated with the store in accordance with some aspects of the present technology;

FIGS. 4A, 4B, 4C, and 4D illustrate example user interfaces in accordance with some aspects of the present technology;

FIGS. 5A, 5B, 5C, 5D, and 5E illustrates example user interface in accordance with some aspects of the present technology; and

FIG. 6 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art for a technological solution that will allow a user to engage with their user device in an express transaction to bypass a front-of-house store associate (as they are often engaged with other customers) to initiate the transaction. This would be useful, for example, when a user has already made a purchase and only needs to pick up the order. The present technology can allow a user to interact with their mobile device to communicate with a store server to initiate an order delivery process whereby a back-of-house associate can deliver the products in the order to the user waiting in the store. Since the user does not have to get the attention of a front-of-house associate, the user avoids a potentially lengthy wait time to engage in a quick transaction. Additionally, the front-of-house store associates are freed up to spend more time carrying out their primary responsibility of helping customers engage with products in the store.

As used herein, the term express transaction, or express in-store pickup refers to the characteristic of the transaction wherein a mobile computing device associated with a user can send a communication to a back-of-house system for the store location to initiate the transaction without otherwise involving front-of-house store associates.

In some embodiments, the present technology is achieved when a user carrying their mobile device that is associated with a user account used to order a product, is within a particular store. The mobile device can detect a broadcast signal from a beacon device that includes an identifier for the particular store. Using this identifier, the mobile device can send an eligible orders request to an express pickup service. The request can include the store identifier detected in the broadcast signal and the user account identifier associated with the mobile computing device. In response to the request, the mobile device can receive an identification of an eligible order, and can display a notification of the eligible order. The notification can include a user selectable option to request that the eligible order be brought to the user associated with the mobile computing device, and in response to a selection of the option, the mobile device can send an express pickup request for the eligible order to a store server for the particular store. Thereafter the mobile device may receive and present message(s) indicating a meeting location with the particular physical location of the store, and an estimated wait time. Finally, a store associate can deliver the products in the order to the user at the designated meeting location.

As described above, one aspect of the present technology is the gathering and use of data available from various sources to facilitate an express pickup of an existing order that can bypass unnecessary interactions with front-of-house store associates. The present disclosure contemplates that in some instances, this gathered data may include personal information data that uniquely identifies or can be used to contact or locate a specific person. Such personal information data can include demographic data, location-based data, telephone numbers, email addresses, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine orders eligible for express pickup and to initiate delivery of the order.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of automatically determine orders eligible for express pickup, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, a user could still request pickup of an order by looking up the order manually.

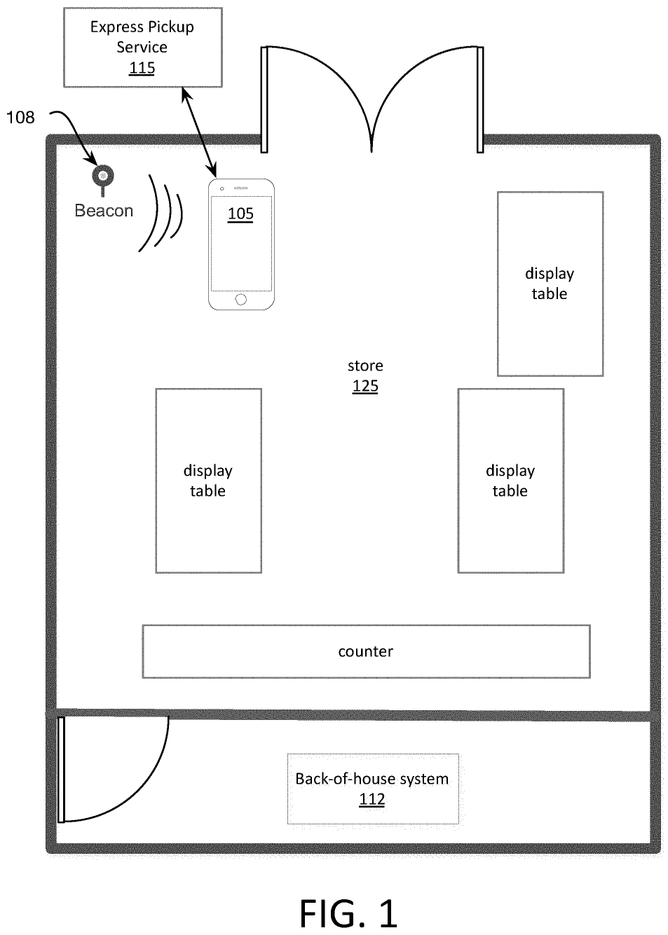

FIG. 1 illustrates an example environment in which some embodiments of the present technology are useful. FIG. 1 illustrates store 125. In the context of this description store 125 can be a particular location of a business having many locations, or store 125 can be the sole location for the business. In some embodiments, store 125 can receive orders from an online storefront, wherein users can place orders for products to be picked up in store 125.

Store 125 can be divided into two logical parts. The front part of the store can be termed the “front-of-house” 121, and the back part of the store can be termed “back-of-house” 123. The term front-of-house refers to the portion of store 125 in which a customer traditionally interacts (e.g., front-of-house 121). This is the portion of store 125 in which products are arranged for display, store associate that are trained for customer interaction are present, and where point-of-sale systems and customer service stations are typically located.

The term back-of-house refers to the portion of store 125 which is commonly reserved for storing inventory, and store associates that interact with the inventory (e.g., back-of-house). Store associates that are assigned to back-of-house roles typically are not trained for customer interaction and have roles such as runners that take inventory to front-of-house 121 upon request, and stock clerks that receive and process new inventory.

As stated above, one benefit of the present technology is that the customer 102 can trigger back-of-house assistance without interacting with front-of-house store associates. For example, user (customer) 102 can have placed an order with an online storefront associated with store 125 that user 102 has requested to pick up from store 125.

When user 102 enters store 125, user 102's mobile computing device 105 can receive a broadcast signal transmitted from beacon 108. The broadcast signal transmitted from beacon 108 can include data such as a unique identifier for store 125. Mobile computing device 105 can identify the data as a unique identifier for store 125 and can then send an eligible order request to express pickup service 115 to learn if user 102 has any orders eligible for express in-store pickup. The eligible order request can include the unique identifier for store 125 and a user account identifier for a user account of user 102.

When express pickup service 115 identifies an order eligible for express in-store pickup for the store and user account identified in the eligible order request, express pickup service 115 can send information identifying the eligible order.

When mobile computing device 105 receives the response from express pickup service 115 identifying the eligible order, mobile computing device 105 can present a notification on the display of mobile computing device 105 to notify user 102 of the eligible order. Up to this point user 102 has not taken any action other than entering the store.

After being notified of the eligible order, user 102 can operate mobile computing device 105 to request pickup of the eligible order. In response to receiving the necessary user inputs, mobile computing device 105 can communicate with back-of-house system 112 specific to store 125 to notify back-of-house associates of the order identifying information and the user 102's request to pick up the order, which can then be fulfilled.

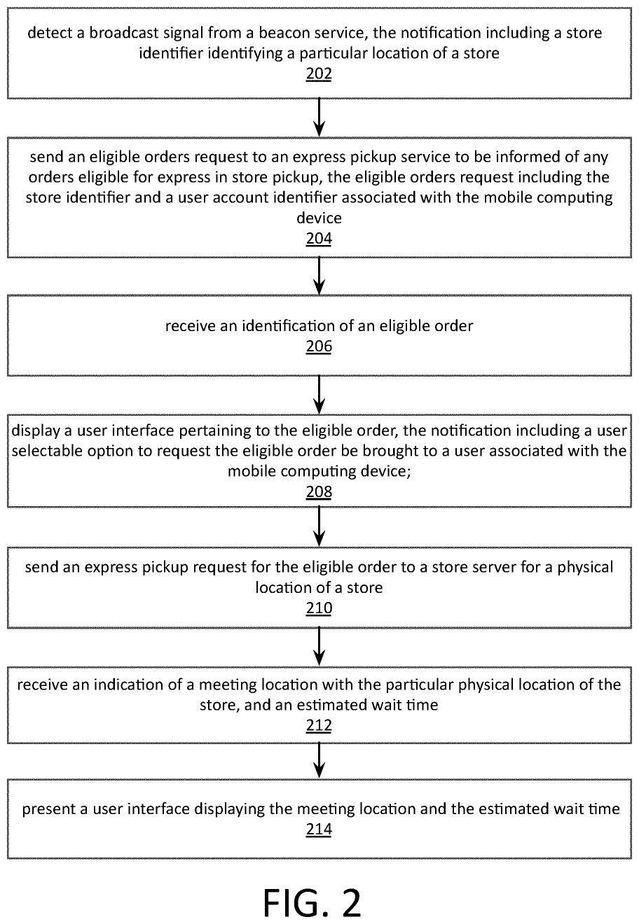

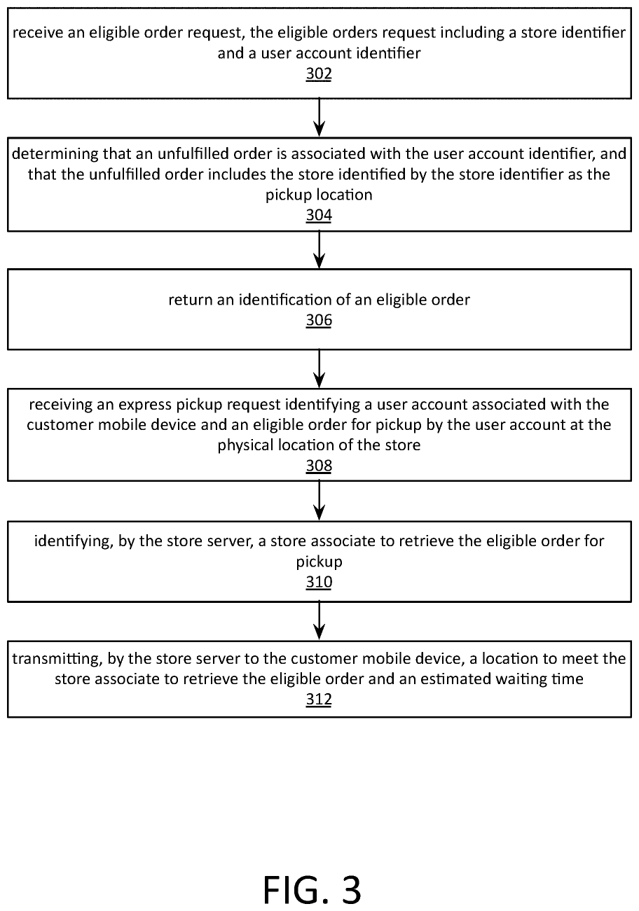

FIG. 2 and FIG. 3 addresses example methods for carrying out the present technology in greater detail. FIG. 2 pertains to an example method performed by mobile computing device 105, while FIG. 3 pertains to an example method performed by express pickup service 115 and back-of-house system 112. These methods are addressed together in the following paragraphs for convenience and clarity of explanation.

In FIG. 2, when user 102 enters store 125 while carrying mobile computing device 105, mobile computing device 105 can detect (202) a broadcast signal being transmitted by beacon 108. In some embodiments, beacon 108 is a low-power Bluetooth® transmitter capable of providing one-way communications to receiving devices such as mobile computing device 105. Beacons such as beacon 108 can encode information pertaining to a unique identifier of the company hosting the beacon (e.g., it is an Apple Store hosting the beacon) and information pertaining to location of the beacon (e.g., it is the Apple Store in San Francisco, Calif.).

Mobile computing device 105, using software executing thereon, can recognize the unique identifier in the notification as being relevant to that software. More specifically mobile computing device 105 can have a store application associated with store 125 being executed as a background process on mobile computing device 105. The application associated with store 125 can be programmed to recognize the unique identifier in the notification (e.g., an Apple Store application can recognize the unique identifier for the Apple Store in Palo Alto, Calif.), and upon recognizing the unique identifier it can perform various processes to the benefit of user 102 and/or store 125. As described above, such services running in the background or in the foreground on mobile computing device 105 that make use of user 102's location or other data should only do so in accordance with acceptable privacy policies.

When the application associated with store 125 executing on mobile device 105 recognizes the unique identifier in the notification, the application can cause mobile computing device 105 to automatically (without explicit user input) to send (204) an eligible orders request to express pickup service 115. The purpose of the eligible orders request is to determine whether user 102 has any orders eligible for express in-store pickup. The eligible orders request includes at least the identifier for the particular store received from the broadcast signal from beacon 108 and user account identifier associated with mobile computing device 105.

User 102 can have a user account with store 125 and its online store. The user account identifier can be a portion of the log-in credentials needed to take any actions on behalf of user 102. In some embodiments, the application associated with store 125 can use the user account identifier to log-in to user 102's user account, and in this way the user account identifier is associated with and known to the mobile computing device 105.

As illustrated in FIG. 3, express pickup service 115 can receive (302) the eligible order request that includes the particular store identifier and the user account identifier. In some embodiments, express pickup service 115 can be a cloud hosted service or can be hosted on an enterprise server for store 125. Express pickup service 115 can be associated with the online store associated with store 125.

When express pickup service 115 receives (302) the eligible order request, express pickup service 115 can perform a collection of checks to determine (304) if there are any orders eligible for express in-store pickup by user 102 of the user account at the particular location of the store. For example, the user identifier included in the eligible order request must be associated (e.g., be the user account that made the order) with any eligible order, and the order must have the particular location of the store as the pickup location. Additionally, the particular location of the store must be offering express in-store pickup. The store must also be currently opened. Additionally the user account identifier must not be associated with any unacceptable fraud risk. More or less checks or criteria can be employed.

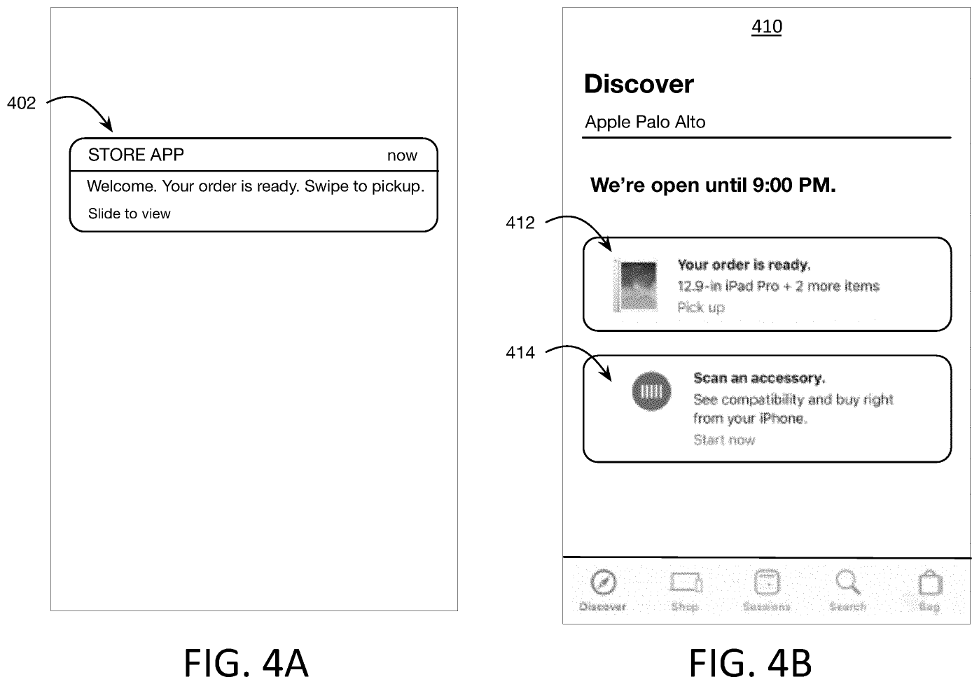

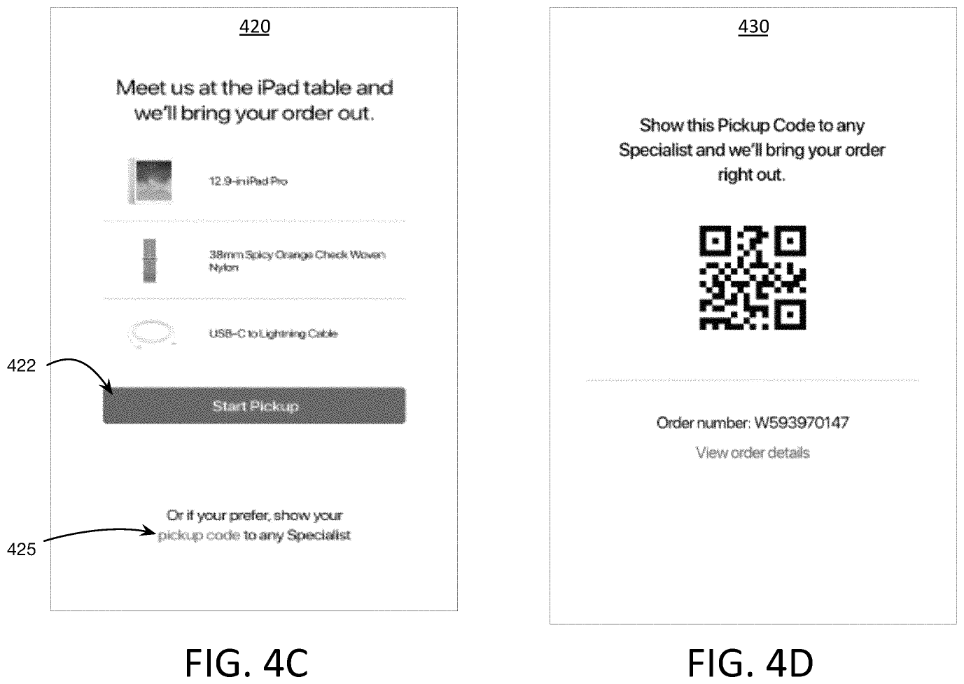

In some embodiments, express pickup service 115 may identify an order that is ready for pickup, but that does not qualify for express pickup. In such embodiments, express pickup service 115 can send a notification to mobile computing device 105 to inform user 102 that an order is ready for pickup, and that user 102 should see a front-of-house associate for help. In some embodiments, mobile computing device 105 can receive a machine readable code (see e.g., FIG. 4D) that identifies the order to a computing device carried by a front-of-house associate.

In the embodiments wherein express pickup service 115 determines (304) that there is an unfulfilled order that is eligible for express pickup, express pickup service 115 can return (306) an identification of the eligible order to mobile computing device 105.

Returning to FIG. 2, mobile computing device 105 can receive (206) the identification of the eligible order from express pickup service 115. The identification of the eligible order can include a unique code identifying the eligible order along with other information useful in describing the order to user 102.

After receiving (206) the identification of the eligible order, mobile computing device 105 can display (208) a notification (see e.g., FIG. 4A and FIG. 4B) of the eligible order on the screen of mobile computing device 105. After user 102 sees the notification, user 102 can operate mobile computing device 105 to select the notification, which can result in mobile computing device displaying (208) one or more user interfaces (see e.g., FIG. 4C) pertaining to the eligible order that includes a user selectable option to request the eligible order be brought to user 102 within store 125. User 102 can operate mobile computing device 105 to select the user selectable option, which can result in mobile computing device 105 sending (210) an express pickup request for the eligible order to a store server, such as back-of-house system 112. The express pick up request can identify the user account associated with customer mobile device 105 and the unique identifier pertaining to the eligible order.

Returning to FIG. 3, the store server can receive (308) the express pickup request.

The store server is any physical or virtual server that runs at least some back-of-house system 112 for the particular store. As such the store server can be a combination of a server in an off-site data center communicating with a client computer located at store 125 or the store server can be physically located on-premise of store 125. While back-of-house system 112 may be configured to interface with front-of-house systems such as a point-of-sale system, in some embodiments, back-of-house system 112 is at least logically separate from the front-of-house systems. In some embodiments, back-of-house system 112 can include an inventory service and a runner service. The inventory service can keep track of available inventory, and keep track of inventory reserved for orders yet to be picked up. The runner service can notify back-of-house associates when a particular product needs to be retrieved from inventory and brought to front-of-house 121. Additionally the runner service can keep track of which orders a particular associate is currently servicing to prevent redundant fulfillment of orders.

When the store server receives (308) the express pickup request, the store server can provide the information in the express pickup request to the inventory service and the runner service of back-of-house system 112. In some embodiments, the runner service allows a store associate to see pending requests and then pick a request to serve by claiming the eligible order for pickup. In some embodiments, the runner service can select a store associate to retrieve the eligible order to pickup. Using either mechanism, back-of-house system 112 identifies (310) a store associate that will deliver the eligible order to the user. Once the store associate has been identified (310), the store server can transmit (312) a message to mobile computing devices 105 that includes a location to meet the store associate within store 125 to retrieve the eligible order and an estimated waiting time.

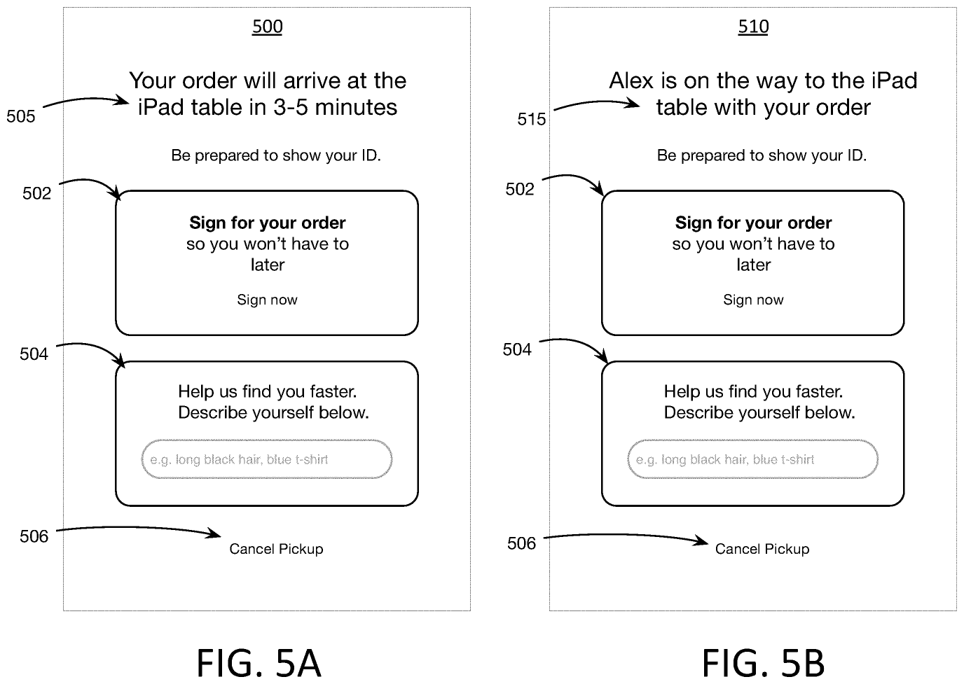

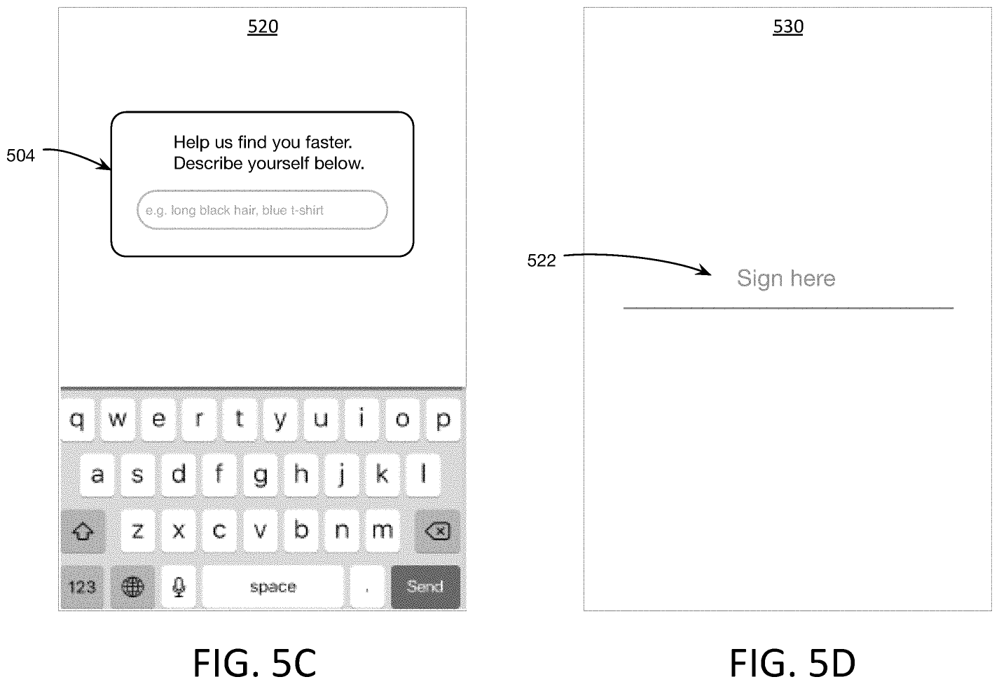

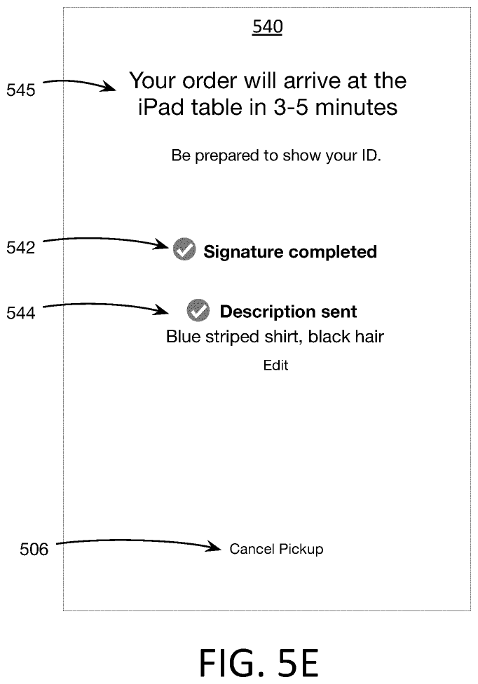

Returning to FIG. 2, mobile computing device 105 can receive (212) the message from the store server that indicates in meeting location within the particular store, store 125, and the estimated wait time, and can present (214) the meeting location and the estimated wait time on the display of mobile computing device 105 (see e.g., FIG. 5A, FIG. 5B, and FIG. 5E).

FIGS. 4-5 illustrate example notifications and screens presented on mobile computing device 105.

FIG. 4A illustrates notification 402 that can be displayed by mobile computing device 105 after receiving (206) an identification of an eligible order from express pickup service 115. Notification 402 can be displayed on a notification screen or on a lock screen of mobile device 105. User 102 can operate mobile computing device 105 to select notification 402 by interacting with a touch sensitive display of mobile computing device 105 or other interface for receiving user inputs, and in turn mobile computing device 105 can receive the input selecting notification 402 through its user interface.

A selection of notification 402 can cause mobile computing device 105 to launch a store application associated with store 125, which can cause display of page 410 illustrated in FIG. 2B. Page 410 of the store application includes a user selectable option 412 providing more details to user 102 regarding the order that is available for in-store pickup. Page 410 also provides an option 414 to allow user to operate mobile computing device 105 to utilize the camera of mobile computing device 105 to be used to read a barcode of an accessory displayed in store 125 and to initiate a purchase process.

When mobile computing device 105 receives a user input provided by user 102 that selects selectable option 412 regarding the order of user 102 that is ready for in-store pickup, the store application can proceed to page 420 displayed in FIG. 4C. Page 420 displays each product in the order that is available for in-store pickup and provides selectable option 422 to start express pickup of the order. After mobile computing device 105 receives an input from user 122 selecting selectable option 422, mobile computing device 105 can proceed to send (210) the express pickup request (addressed above with respect to FIG. 2).

Page 420 also provides an alternative option 425, which can be selected to initiate an alternative in-store pickup process that requires user 102 to interact with a front-of-house associate. FIG. 4D illustrates page 430 of the store application and displays a machine readable code (e.g., QR code, barcode, etc.) that user 102 can present to a front-of-house store associate to initiate the alternative in-store pickup process. This alternative option can also be used for orders that are not eligible for express in-store pickup as determined in step 304 in FIG. 3.

Assuming user 102 has selected to proceed with the express in-store pick up process by selecting selectable option 422 in FIG. 4C, mobile computing device 105 sends (210) the express pickup request to back-of-house system 112, and then back-of-house system 112 can identify (310) a store associate to retrieve the eligible order for pickup, and can transmit (312) and location to meet the store associate and an estimated waiting time to mobile computing device 105 (addressed above with respect to FIG. 3). As addressed with respect to FIG. 2 mobile computing device 105 can receive (212) the indication of the meeting location and the estimated wait time, and present (214) page 500 as illustrated in FIG. 5A. Page 500, displayed by the store application on mobile computing device 105, informs user 102 with notification 505 that the order will arrive at the iPad table in 3 to 5 minutes, and that the user should be prepared to show their ID. Page 500 additionally provides option 502 to allow user 102 to sign for the order in advance, and an interface 504 to provide a description of themself to help the store associate to find them. Page 500 also includes option 506 to cancel the pickup request.

Once the store associate has retrieved the order and is on their way to deliver the order to user 102, the store application can display and additional page 510 as shown in FIG. 5B. Page 510 also includes a status notification 515 naming the store associate and informing user 102 that the store associate is on their way to the meeting location. Page 510 also includes option 502 to sign for the order in advance, and interface 504 to describe themself.

When user 102 operates mobile device 105 to select interface 504 shown on page 500 or page 510, the store application can display page 520 that provides a keyboard to allow user 102 to enter a description of themself, which description is sent to back-of-house system 112 to be forwarded to the store associate handling the order.

When user 102 operates mobile device 105 to select interface 502 shown on page 500 or page 510, the store application can display page 530 in FIG. 5D that provides an interface for a user to enter a signature by manipulating a user interface to draw their signature on mobile computing device 105.

FIG. 5E shows page 540 which is displayed by the store application on mobile computing device 105. Page 540 includes a status notification 545, and notification 542 showing that the user provided signature from FIG. 5D has been completed, and notification 544 that the user provided description of themself (wearing a blue stripe shirt and having black hair) has been received.

While the embodiments addressed above have referred to an in-store pickup of an order, it should be appreciated that the order is not limited to new devices. In some embodiments, the order can refer to a repair service on a device the user has dropped off for servicing.

While the embodiments addressed above have discussed using an agreed-upon meeting spot within store 125 for the store associate to meet user 102 to deliver the order, in some embodiments, the present technology can make use of micro-location technology to allow the store associate to find user 102 roaming anywhere in store 125. In such embodiments, mobile computing device 105 can be interacting with a plurality of beacons, WiFi and other indoor location technologies to determine its likely location within store 125 and mobile computing device 105 can report its likely location in the store to back-of-house system 112 with some amount of frequency. Using this technique it can be possible for the store associate using their own mobile computing device to be able to determine where user 102 is within store 125. Use of such micro-location info requires explicit consent from the user, and has an automatic stop condition based on location (e.g., when user leaves the store), time (e.g., a certain amount of time has elapsed since user initiates the pickup process), and status change of pickup (e.g., the order has been handed over to the customer).

In some embodiments, it may also be possible to use augmented reality technologies to facilitate the meeting between user 102 and the store associate, or a particular location or object inside the store. In such embodiments, user devices 105 could receive information regarding some definable characteristic or marker of the store associate delivering the order that can be recognizable to mobile computing device 105 analyzing frames recorded by a camera of mobile computing device 105. For example mobile computing device 105 could receive facial recognition characteristics for the particular store associate delivering the order can use these facial recognition characteristics to recognize the store associate. Another example is that the mobile computing device 105 recognizes a location or object (such as a dedicated table, or sign on the wall or shelf) in the store, and it can provide a visually perceptible label on the display of the mobile device identifying the meeting location, or the path to the meeting location, to user 102. Alternatively store associate could be carrying a recognizable flag or device emitting a signature detectable by mobile computing device 105. When mobile computing device 105 recognizes store associate in the field of view of the camera of mobile computing device 105 the mobile computing device can provide a visually perceptible label on the display of the mobile device identifying the store associate to user 102. Alternatively, the store associate could use their computing device to recognize user 102 is much the same way as described above with respect to user 102 recognizing the store associate. Such embodiments, should only be deployed with user consent an in accordance with acceptable privacy policies.

While the majority of this description has provided using a use case of an express in-store pickup transaction, persons of ordinary skill in the art will appreciate that this is just one type of transaction that can be performed using the principles of the present technology described herein. The present technology can be useful to initiate other types of transactions using a mobile computing device associated with a user that sends a communication to a back-of-house system for the store location to initiate the transaction without otherwise involving front-of-house store associates.

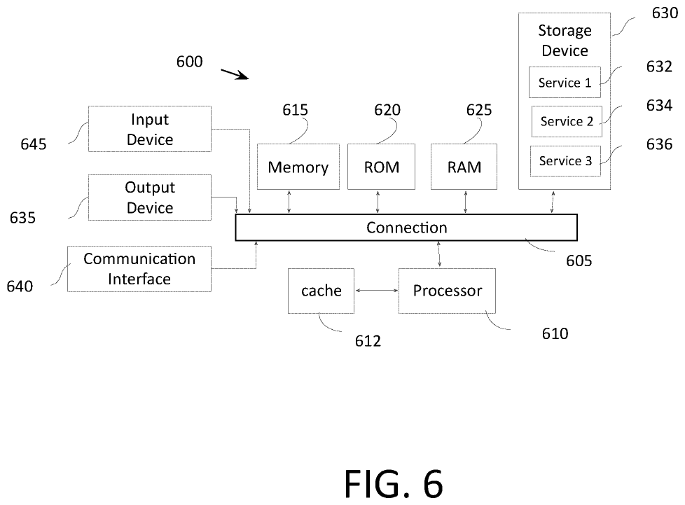

FIG. 6 shows an example of computing system 600, which can be for example any computing device making up mobile computing device 105, express pickup service 115, or back-of-house system 112 or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A non-transitory computer readable medium comprising instructions stored thereon, when executed the instructions are effective to cause a mobile computing device to:
detect a broadcast signal from a beacon service, the signal including a store identifier including an identification of a particular store;
send an eligible orders request to receive any orders eligible for express in-store pickup, the eligible orders request including the identification of the particular store and a user account identifier associated with the mobile computing device;
receive an identification of an order eligible for express in-store pickup;
display a notification of the order eligible for express in-store pickup, the notification including a user selectable option to request the order eligible for express in-store pickup be brought to a user associated with the mobile computing device; and
sending an express pickup request for the eligible order, the express pickup request identifying the eligible order and the user account.

2. The non-transitory computer readable medium of claim 1, wherein the eligible orders request is sent to an express pickup service, the express pickup service being a cloud based service.

3. The non-transitory computer readable medium of claim 1, wherein the express pickup request is sent to the store server for the particular store.

4. The non-transitory computer readable medium of claim 1, wherein the express pickup request is sent to a back-of-house service for the particular store.

5. The non-transitory computer readable medium of claim 1, wherein the instructions are effective to cause the mobile computing device to:
receive an indication of a meeting location within the particular store, and an estimated wait time; and
present the meeting location and the estimated wait time.

6. The non-transitory computer readable medium of claim 1, wherein the instructions are effective to cause the mobile computing device to:
present a user interface to receive a description of the user; and
send the description of the user to the store server.

7. The non-transitory computer readable medium of claim 1, wherein the instructions are effective to cause the mobile computing device to:
determine a micro-location within the particular store; and
transmit the micro-location to the store server for the particular store.

8. The non-transitory computer readable medium of claim 1, wherein the instructions are effective to cause the mobile computing device to:
prior to delivery of the eligible order to the user, presenting a request to receive a signature of the user, wherein the signature is required to claim the eligible order.

9. A method comprising:
receiving, from a customer mobile device, at a store server for a particular store, an express pickup request identifying a user account associated with the customer mobile device and an eligible order for pickup by the user account at the store;
identifying, by the store server, a store employee to retrieve the eligible order for pickup;
transmitting, by the store server to the customer mobile device, a notification including a message that the order is being brought to the user.

10. The method of claim 9 comprising:
receive an eligible order request to be informed of any orders eligible for express in-store pickup, the eligible orders request including a store identifier for the particular store and a user account identifier;
determining whether there is an eligible order that is associated with the user account identifier, and that the eligible order includes the store identified by the store identifier as the pickup location.

11. The method of claim 10, wherein the determining whether there is an eligible order further comprises:
determining that the particular store identified by the store identifier supports express in-store pickup.

12. The method of claim 9, wherein the store server is a back of house system.

13. The method of 10, wherein the determining whether there is an eligible order comprises:
determining that there is an order available for pickup, but that it is not eligible for express in-store pickup;
sending a communication to the customer mobile device indicating an order number, and that the order is not eligible for express in-store pickup.

14. The method of claim 10, wherein the determining whether there is an eligible order comprises:
determining that there is an order available for express pickup; and
sending a communication to the customer mobile device indicating an order number, and that the order is available for express in-store pickup.

15. A mobile computing device comprising instructions stored on a storage of the mobile computing system that when executed are effective to cause the mobile computing device to:
display, by the mobile computing device, a notification of an order eligible for express in-store pickup at a particular store, the notification including a user selectable option to request the order eligible for express in-store pickup be brought to a user associated with the mobile computing device; and
send an express pickup request for the eligible order to a back-of-house system for the particular store, the express pickup request identifying the eligible order and the user account.

16. The mobile computing device of claim 15 wherein the instructions cause the mobile computing device to:
after the express pickup request is sent, receive an indication of a meeting location within the particular store, and an estimated wait time; and
present the meeting location and the estimated wait time on a display on the mobile computing device.

17. The mobile computing device of claim 15 wherein the instructions cause the mobile computing device to:
present a user interface to receive a description of the user; and
send the description of the user to the store server.

18. The mobile computing device of claim 15 wherein the instructions cause the mobile computing device to:
present a request to receive a signature of the user on a display of the mobile computing device, wherein the signature is required to claim the eligible order.

19. The mobile computing device of claim 15 wherein the instructions cause the mobile computing device to:
send an eligible order request to receive any orders eligible for express in-store pickup, the eligible orders request including an identification of a particular store and a user account identifier associated with the mobile computing device.

20. The mobile computing device of claim 19 wherein the instructions cause the mobile computing device to:
after the eligible order request is sent, receive an identification of the order eligible for express in-store pickup and then display the notification of the order eligible for express in-store pickup.

21. The mobile computing device of claim 19 wherein the instructions cause the mobile computing device to:
after the eligible order request is sent, receive an identification of an order eligible in-store pickup, but that it does not qualify for express in-store pickup;
display a notification on a display of the mobile computing device including a machine readable code, and informing the user to present the mobile computing device displaying the machine readable code to a front-of-house store associate to pickup the order eligible for in-store pickup.

22. The mobile computing device of claim 15 wherein the instructions cause the mobile computing device to:
use indoor location technology to report a micro-location of the mobile computing device within the particular store to the back-of-house system whereby the user can freely roam inside the particular store during waiting, and the store employee can find the user using the reported micro-location.

23. The mobile computing device of claim 15 wherein the instructions cause the mobile computing device to:
use augmented reality technology to use a camera of the mobile computing device to recognize a meeting location, an object in the particular store, or a face of a store associate, and provide a visually perceptible label on the display of the mobile device.
